(19) United States
(12) Patent Application Publication
(10) Pub. No.: US 2005/0008769 A1
(43) Pub. Date: Jan. 13, 2005

(54) Methods of manufacturing wiring pattern, organic electro luminescent element, color filter, plasma display panel, and liquid crystal display panel, and electronic apparatus

(75) Inventor: Hirofumi Sakai, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/847,446

(22) Filed: May 18, 2004

(30) Foreign Application Priority Data
Jun. 2, 2003 (JP) 2003-156869

(51) Int. Cl. B05D 5/06; H01J 9/00; H01J 9/24; B05D 5/12; B05D 5/00

(52) U.S. Cl. 427/66; 427/258; 445/24

(57) ABSTRACT

Methods of manufacturing a thin film pattern, an organic electro-luminescent element, a color filter, a plasma display panel, and a liquid crystal display panel, and an electronic apparatus in which the generation of streak unevenness in a thin film pattern can be reduced or prevented or the streak unevenness can be dispersed are provided when the thin film pattern constituting a pixel is formed using a droplet ejecting method. A liquid applying treatment where a liquid material is applied to a pixel area having a major axis and a minor axis by a droplet ejecting method, and an ejecting treatment along minor axis direction where, in the liquid applying treatment, a nozzle head of a droplet ejecting apparatus is scanned along a minor axis direction of the pixel area (a direction of scanning lines L1, L2, and L3), and a droplet is ejected to the pixel area from an inkjet nozzle included in the nozzle head in the scanning process.

### BACKGROUND OF THE INVENTION

1. Field of Invention

The present invention relates to methods of manufacturing a thin film pattern, an organic electro-luminescent device, a color filter, a plasma display panel, and a liquid crystal display panel in which a droplet ejecting method is used, and an electronic apparatus.

2. Description of Related Art

A display panel using an organic electro-luminescent element has been contrived in the related art. A basic structure of an organic electro-luminescent element is formed by interposing a solid-state thin film (light emitting layer) including fluorescent organic molecules between two electrodes (cathode and anode). When voltage is applied to the electrodes, holes from the anode and electrons from the cathode are injected into the light emitting layer and thus fluorescence is emitted from the light emitting layer.

A single layer structure element including only a light emitting layer has low light emitting efficiency and has a problem with endurance such that a two layer structure element where a hole injection layer (hole injection and transport layer) having good adhesiveness is provided between the anode and light emitting layer has been proposed. This multi-layer structure enables the light emitting efficiency and endurance of an organic electro-luminescent element to be enhanced since balance of injection and transport of carriers, and recombination site of carriers are controlled. In addition, in this multi-layer structure, functions, such as light emitting, and injection and transport can be allotted to different materials such that there is an advantage that optimal design for materials and element are possible.

As a hole injection and transport layer compound of a related art two layer organic electro-luminescent element, a porphyrin compound, aniline, pyridines, derivative small molecules of aniline and pyridines, or a hole injection and transport layer using a carbon layer has been proposed. A depositing method utilizing vacuum deposition or sputtering is generally used to form a hole injection and transport layer using these small molecule materials. As a polymeric material, poly aniline and so on is known and is deposited by a wet process, such as spin coating.

### SUMMARY OF THE INVENTION

A deposition method utilizing vacuum deposition or sputtering is implemented by batching and thus takes a long time such that mass production efficiency is low. Furthermore, in the case of a small molecule material, there is a problem that crystallization is easy to occur after deposition such that reliability of an element is decreased. In the case of a polymeric material, although there is an advantage that optimization for materials is easy since the versatility of molecule design is high and a wet process is used, there is a large problem that most of used materials are wasted in a deposition method, such as spin coating.

In a case where micro patterning is required when fabricating a full color display, there is a problem that high accuracy patterning is difficult in an evaporation method. Endurance of materials is insufficient for a patterning process by photolithography. The same problem also applies to a polymeric material. Furthermore, if complete patterning is not achieved, short-circuit between adjacent pixels formed on the same substrate may be caused since the material used as a hole injection layer or a buffer layer has electrical conductivity.

In order to address the above problems, specifically, in order to implement pattern deposition where design of materials and element can be optimized and that is easy, short time-consuming, low cost, and has high accuracy, a method of manufacturing a hole injection layer and light emitting layer using a droplet ejecting method has been contrived. In the manufacturing method using a droplet ejecting method, a droplet including a component of a hole injection layer and a solvent is ejected from an inkjet nozzle to a desired area so as to form a thin film pattern (see Japanese Unexamined Patent Application Publication No. 2000-106278).

In the related art, however, when a thin film pattern constituting a pixel is formed using a droplet ejecting method, a droplet was ejected when scanning an inkjet nozzle along the major axis direction of a pixel area such that unevenness of a streak shape (streak unevenness) is generated along the major axis direction of the pixel.

FIG. 12 is a schematic showing a method of coating a pixel area using a related art droplet ejecting method. As shown in FIG. 12, a pixel area 1 generally has an elongated shape including the major and minor axes, and a scanning line L100 of an inkjet nozzle is arranged along the major axis of the pixel area 1. Droplets are sequentially ejected from the inkjet nozzle while moving the inkjet nozzle along the scanning line L100. The plurality of droplets lands on a line in the pixel area 1 so as to form a thin film pattern having streak unevenness in the pixel area 1.

If such streak unevenness is caused, unevenness of light emitting is caused when the thin film pattern is used as, for example, a hole injection layer, a light emitting layer, or a color filter of a pixel since the thickness of the thin film pattern is uneven.

In the formation of a thin film pattern constituting a pixel using a related art droplet ejecting method, a droplet is ejected using one inkjet nozzle in one scanning for one pixel area. Thus, there is a problem that long time is required to form the thin film pattern.

In view of the above problems, the present invention provides methods of manufacturing a thin film pattern, an organic electro-luminescent element, a color filter, a plasma display panel, and a liquid crystal display panel, and an electronic apparatus in which the generation of streak unevenness in a thin film pattern can be reduced or prevented or the streak unevenness can be dispersed when the thin film pattern constituting a pixel is formed using a droplet ejecting method.

The invention provides methods of manufacturing a thin film pattern, an organic electro-luminescent element, a color filter, a plasma display panel, and a liquid crystal display panel, and an electronic apparatus in which a thin film pattern constituting a pixel can be formed at high speed by a droplet ejecting method.

In order to achieve the above, a method of manufacturing a thin film pattern of one aspect of the present invention includes a liquid applying treatment where a liquid material is applied to a pixel area having a major axis and a minor axis by a droplet ejecting method, and ejecting treatment along minor axis direction where, in the liquid applying treatment, a nozzle head of a droplet ejecting apparatus is scanned along a minor axis direction of the pixel area, and droplets are ejected to the pixel area from an inkjet nozzle included in the nozzle head in the scanning process.

According to an aspect of the invention, while scanning the nozzle head along the minor axis direction of the pixel area, droplets are ejected to the pixel area from the inkjet nozzle of the nozzle head. Thus, a thin film that becomes a structural element of a pixel can be formed. Thus, ejection of multiple droplets with a plurality of inkjet nozzles formed in the nozzle head for one pixel area becomes easier compared to the case of scanning the nozzle head along the major axis direction of the pixel area. This is because, even in the case where only one inkjet nozzle transverses above the pixel area when the nozzle head is scanned along the major axis direction of the pixel area, a plurality of inkjet nozzles disposed in the nozzle head at even intervals transverse above the pixel area if the nozzle head is scanned along the minor axis direction.

Furthermore, according to an aspect of the invention, it becomes easier to eject droplets with a plurality of inkjet nozzles for one pixel area as above. The difference in ejection amount among inkjet nozzles therefore can easily be offset such that the generation of “streak unevenness” in a thin film constituting a pixel can be reduced. Thus, the film thickness of a thin film constituting a pixel can easily be uniformized, enabling light emitting unevenness and so on to be reduced.

According to an aspect of the invention, it becomes easier to eject a plurality of droplets almost simultaneously or sequentially with a plurality of inkjet nozzles adjacent to each other for one pixel area such that the speed of applying a liquid to the pixel area by a droplet ejecting method can easily be enhanced.

In a method of manufacturing a thin film pattern of an aspect of the invention, droplet ejecting of multiple times may be implemented for a single pixel area in the ejecting treatment along minor axis direction. The inkjet nozzle may include a plurality of inkjet nozzles. The droplet ejecting of multiple times may be implemented with at least two of the inkjet nozzles different from each other.

According to an aspect of the invention, droplet ejecting of multiple times for one pixel area is implemented using more than two inkjet nozzles such that the difference (error) in droplet ejection amount among inkjet nozzles can be offset. In the related art, for example, droplet ejecting of multiple times is implemented with only an inkjet nozzle of small ejection amount for one pixel area, and droplet ejecting of multiple times is implemented with only an inkjet nozzle of large ejection amount for another pixel area such that the error for ejection amount is accumulated, causing the difference in amount of ejected (applied) droplet for pixel area to increase. As a result, “streak unevenness” tends to appear in a screen as a whole. The invention enables the difference in droplet ejection amount for pixel area to be reduced, preventing “streak unevenness” from appearing in a screen as a whole.

In a method of manufacturing a thin film pattern of an aspect of the invention, the nozzle head may include a plurality of inkjet nozzles. The droplet ejecting of multiple times for a single pixel area may be implemented almost simultaneously or sequentially with at least two of the inkjet nozzles adjacent to each other.

According to an aspect of the invention, since droplets are ejected almost simultaneously or sequentially with a plurality of inkjet nozzles adjacent to each other for one pixel area, liquid can be applied for the whole pixel area (and also for each of multiple pixel areas disposed on the whole substrate) at high speed, while the difference in the droplet ejection amount among inkjet nozzles is offset so as to reduce “streak unevenness”.

In a method of manufacturing a thin film pattern of an aspect of the invention, the droplet ejecting of multiple times for a single of the pixel area may be implemented with droplet ejection amounts of at least two kinds.

According to an aspect of the invention, droplets can be ejected with droplet ejection amounts of two or more kinds for one pixel area by controlling the droplet ejection amount of each inkjet nozzle and the like.

Thus, a high precision thin film having even thickness for the whole pixel area can be formed at high speed by decreasing the droplet ejection amount for corner parts of the pixel area, and increasing that for the center part of the pixel area, for example.

In a method of manufacturing a thin film pattern of an aspect of the invention, the droplet ejecting of multiple times for a single of the pixel area may be implemented with viscosities of at least two kinds of the droplets.

According to an aspect of the invention, liquid having desired viscosity can be applied to a desired place of the pixel area by changing the viscosity of the supplied liquid by each inkjet nozzle, for example. Thus, a high precision thin film having more even thickness for the whole pixel area can be formed.

In a method of manufacturing a thin film pattern of an aspect of the invention, the nozzle head may include a plurality of inkjet nozzles. The plurality of inkjet nozzles may be disposed on a substantially straight line in the nozzle head. The nozzle head may be scanned while the straight line defining a location of the plurality of inkjet nozzles diagonally intersects with a scanning line arranged along the minor axis direction, in the ejecting treatment along minor axis direction.

According to an aspect of the invention, the nozzle head is scanned while the nozzle head diagonally intersects with the scanning line defining the movement position of the nozzle head. This makes the interval of movement paths (scanning lines for each inkjet nozzle) of a plurality of inkjet nozzles formed in the nozzle head to be shorter than the interval of inkjet nozzles. Thus, droplets can easily be ejected almost simultaneously or sequentially with more inkjet nozzles for one pixel area such that a thin film pattern constituting a pixel can be formed at higher speed while reducing “streak unevenness” for a large pixel as well as a small pixel.

In a method of manufacturing a thin film pattern of an aspect of the invention, the last droplet may be ejected before the droplet that has landed on the pixel area first is almost completely dried, in the droplet ejecting of multiple times for a single of the pixel area.

According to an aspect of the invention, since droplets for the whole of one pixel area are ejected so as to form a thin film before each of multiple droplets that have landed on the pixel area are completely dried, a high precision pattern having more even thickness can be formed.

In a method of manufacturing a thin film pattern of an aspect of the invention, such a drying process that the droplets that have landed on the pixel area are not completely dried may be implemented between the first droplet ejecting and the last droplet ejecting for the pixel area, in the droplet ejecting of multiple times for a single of the pixel area.

According to an aspect of the invention, in the process of droplet ejecting of multiple times for one pixel area, such an intermediate drying process that droplets that have landed are not completely dried is implemented such that further droplet ejecting can be implemented after the volume of droplets that have landed is decreased by the intermediate drying process. Thus, a thin film pattern having large, as well as even, thickness can be formed while reducing or preventing droplets from spilling out of the pixel area, in the process of droplet ejecting of multiple times for one pixel area.

A method of manufacturing a thin film pattern of an aspect of the invention may include ejecting treatment along major axis direction where, in the liquid applying treatment, the nozzle head of the droplet ejecting apparatus is scanned along a major axis direction of the pixel area. Droplets are ejected to the pixel area from the inkjet nozzle included in the nozzle head in the scanning process.

Since the method of an aspect of the invention includes the ejecting treatment along minor axis direction where the nozzle head is scanned along the minor axis direction of the pixel area, and the ejecting treatment along major axis direction where the nozzle head is scanned along the major axis direction of the pixel area, a state of droplet ejecting for each of the pixel areas can be reduced or prevented from biasing toward a linear state. Thus, the generation of “streak unevenness” in a thin film pattern constituting a pixel can be avoided more effectively.

In a method of manufacturing a thin film pattern of an aspect of the invention, the nozzle head may be scanned while a straight line defining a location of the plurality of inkjet nozzles diagonally intersects with a scanning line arranged along the major axis direction, in the ejecting treatment along the major axis direction.

According to an aspect of the invention, in the ejecting process along the major axis direction also, droplets can easily be ejected almost simultaneously or sequentially with more inkjet nozzles for one pixel area. Thus, a thin film pattern constituting a pixel can be formed at high speed while further reducing “streak unevenness” for a large pixel as well as a small pixel.

In a method of manufacturing a thin film pattern of an aspect of the invention, the droplet ejecting of multiple times for a single of the pixel area may be implemented so that part of a thin film formed by landing of one droplet overlaps with part of a thin film formed by landing of another droplet.

According to an aspect of the invention, a thin film pattern having more even thickness can be formed for the whole pixel area without non-coated part.

A method of manufacturing an organic electro-luminescent element of another aspect of the invention is a method of manufacturing an organic electro-luminescent element where a light emitting element having a light emitting layer and a hole injection layer between electrodes is formed over a substrate, and includes forming the hole injection layer by ejecting droplets with an inkjet head formed in a droplet ejecting apparatus. The hole injection layer is formed in a pixel area having a major axis and a minor axis. The inkjet head is scanned along a minor axis direction of the pixel area, and the droplets are ejected to the pixel area from an inkjet nozzle in the scanning process, in the forming of the hole injection layer.

According to an aspect of the invention, in the case where a thin film pattern of a hole injection layer in an organic electro-luminescent element is formed by a droplet ejecting method, the generation of “streak unevenness” in the hole injection layer can be reduced such that a high quality organic electro-luminescent element involving less “light emitting unevenness” can rapidly be manufactured.

A method of manufacturing an organic electro-luminescent element of another aspect of the invention is a method of manufacturing an organic electro-luminescent element where a light emitting element having a light emitting layer and a hole injection layer between electrodes is formed over a substrate, and includes forming the light emitting layer by ejecting droplets with an inkjet head formed in a droplet ejecting apparatus. The light emitting layer is formed in a pixel area having a major axis and a minor axis. The inkjet head is scanned along a minor axis direction of the pixel area, and the droplets are ejected to the pixel area from an inkjet nozzle in the scanning process, in the forming of the light emitting layer.

According to an aspect of the invention, in the case where a thin film pattern. of a light emitting layer in an organic electro-luminescent element is formed by a droplet ejecting method, the generation of “streak unevenness” in the light emitting layer can be reduced such that a high quality organic electro-luminescent element involving less “light emitting unevenness” can rapidly be manufactured.

A method of manufacturing a color filter of another aspect of the invention is a method of manufacturing a color filter formed on a light emitting direction side of a light emitting element that includes a light emitting layer and a hole injection and transport layer between electrodes and is formed over a substrate, and includes forming the color filter by ejecting droplets with an inkjet head formed in a droplet ejecting apparatus. The color filter is formed in a pixel area having a major axis and a minor axis. The inkjet head is scanned along a minor axis direction of the pixel area, and the droplets are ejected to the pixel area from an inkjet nozzle in the scanning process, in the forming of the color filter.

According to an aspect of the invention, for example, in an organic electro-luminescent element where white light is emitted from a light emitting layer of the organic electro-luminescent element and the white light is output to outside through a color filter, a thin film pattern constituting the color filter can be formed uniformly at high speed without causing “streak unevenness”. Thus, color unevenness and so on can be reduced considerably in a display panel including an organic elecro-luminescent element incorporating a color filter.

A method of manufacturing a plasma display panel of another aspect of the invention is a method of manufacturing a plasma display panel having electrodes formed on a substrate, and includes forming the electrodes by ejecting droplets with an inkjet head formed in a droplet ejecting apparatus. The electrodes are formed in a pixel area having a major axis and a minor axis. The inkjet head is scanned along a minor axis direction of the pixel area, and the droplets are ejected to the pixel area from an inkjet nozzle in the scanning process, in the forming of the electrodes.

According to an aspect of the invention, in the case where a thin film pattern constituting an electrode of a plasma display panel is formed by a droplet ejecting method, the generation of “streak unevenness” in the thin film pattern can be reduced such that an electrode of a plasma display panel can be formed precisely and rapidly.

A method of manufacturing a liquid crystal display panel of another aspect of the invention is a method of manufacturing a liquid crystal display panel having a color filter formed on a substrate, and includes forming the color filter by ejecting droplets with an inkjet head formed in a droplet ejecting apparatus. The color filter is formed in a pixel area having a major axis and a minor axis. The inkjet head is scanned along a minor axis direction of the pixel area, and the droplets are ejected to the pixel area from an inkjet nozzle in the scanning process, in the forming of the color filter.

According to an aspect of the invention, in the case where a thin film pattern constituting a color filter of a liquid crystal display panel is formed by a droplet ejecting method, the generation of “streak unevenness” in the thin film pattern can be reduced such that color unevenness and so on in a liquid crystal display panel can greatly be reduced while manufacturing time can be shortened.

In a method of manufacturing a thin film pattern of an aspect of the invention, the liquid material may form a photo resist film.

According to an aspect of the invention, a photo resist film that is formed when various patterns are formed on a substrate by transferring, using a photolithography method for example, can be formed rapidly by the above method of forming a thin film pattern using a droplet ejecting method. In addition, according to an aspect of the invention, the generation of “streak unevenness” in a photo resist film can be reduced such that various thin film patterns can be formed precisely and rapidly using a photo lithography method and a droplet ejecting method.

An electronic apparatus of another aspect of the present invention includes a thin film pattern manufactured using the method of manufacturing a thin film pattern.

According to an aspect of the invention, since an electronic apparatus including a thin film pattern with less “streak unevenness” as a structural element can be provided rapidly, an electronic apparatus including a display part involving less light emitting unevenness can be provided at low cost by using the thin film pattern as a pixel for example. Furthermore, a compact and high performance electronic apparatus where defects hardly occur can be provided by using the above thin film pattern with less “streak unevenness” as a structural element of a semiconductor integrated circuit, for example.

### BRIEF DESCRIPTION OF THE DRAWINGS

FIG. 1 is a schematic showing a method of manufacturing a thin film pattern of a first exemplary embodiment of the present invention;

FIG. 2 is another schematic showing the method of manufacturing a thin film pattern of the first exemplary embodiment;

FIG. 3 is a schematic showing a method of manufacturing a thin film pattern of a second exemplary embodiment of the present invention;

FIG. 4 is a schematic showing a method of manufacturing a thin film pattern of a third exemplary embodiment of the present invention;

FIG. 5 is a schematic showing the modification of the third exemplary embodiment;

FIGS. 6(a)-(c) are schematics showing a method of manufacturing an organic EL device;

FIG. 7 is a sectional schematic showing a method of manufacturing a plasma display panel;

FIG. 8 is a sectional schematic showing a method of manufacturing a liquid crystal device;

FIG. 9 is a schematic showing one example of an electronic apparatus according to the exemplary embodiments;

FIG. 10 is a schematic showing one example of an electronic apparatus according to the exemplary embodiments;

FIG. 11 is a schematic showing one example of an electronic apparatus according to the exemplary embodiments; and

FIG. 12 is a schematic showing a coating method using a related art droplet ejecting method.

### DETAILED DESCRIPTION OF EXEMPLARY EMBODIMENTS

A method of manufacturing a thin film pattern according to exemplary embodiments of the present invention will be described below with reference to accompanying drawings.

First Exemplary Embodiment

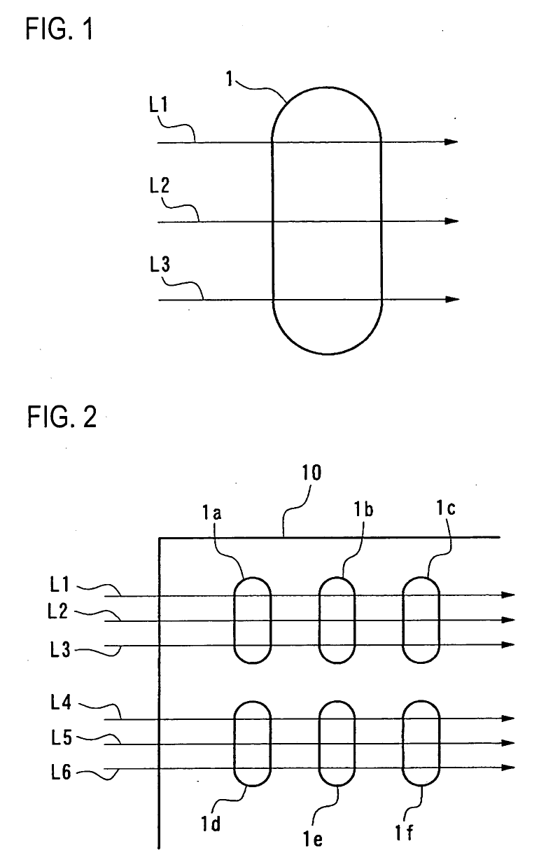

FIG. 1 is a schematic showing a method of manufacturing a thin film pattern according to a first exemplary embodiment of the invention. The pixel area 1 is formed on a substrate. Convex partition walls (banks) may be provided on the circumference of the pixel area 1. The pixel area 1 has an elongated shape, and has a major axis that passes through the center of the pixel area 1 and goes through the pixel area 1 longitudinally, and a minor axis that passes through the center of the pixel area 1 and transverses the pixel area 1. The shape of the pixel area 1 may be rectangle, oval, or the like.

A liquid material is applied to the pixel area 1 by a droplet ejecting method. In the case where a pixel formed in the pixel area 1 is an organic EL element for example, the liquid material includes a material that forms a hole injection layer or a light emitting layer and a solvent. Scanning lines L1, L2, and L3, shown in FIG. 1, are scanning lines virtually arranged in order to define the movement positions of inkjet nozzles that are formed in a nozzle head of a droplet ejecting apparatus. The scanning lines L1, L2, and L3 are arranged in parallel with the minor axis of the pixel area 1.

The inkjet nozzle ejects the liquid material while moving above the scanning line L1 toward the right in the drawing, specifically being scanned in the minor axis direction of the pixel area 1, so as to allow the droplet to land onto the pixel area 1. The inkjet nozzle ejects a droplet while moving above the scanning line L2 toward the right in the drawing so as to allow the droplet to land onto the pixel area 1. The inkjet nozzle ejects a droplet while moving above the scanning line L3 toward the right in the drawing so as to allow the droplet to land onto the pixel area 1.

These operations allow a plurality of droplets to be ejected in the whole of the pixel area 1 dispersedly, such that the liquid material is applied to the whole of the pixel area 1. Then, the applied liquid material is dried. Thus the hole injection layer and light emitting layer are formed.

FIG. 2 is a schematic showing a situation where a liquid material is applied to a plurality of pixel areas formed on a substrate. A plurality of pixel areas 1a, 1b, 1c, 1d, 1e, and 1f are formed on a top surface of a substrate 10. Convex partition walls (banks) may be provided on the circumference of each of the pixel areas 1a, 1b, 1c, 1d, 1e, and 1f. Each of the pixel areas 1a, 1b, 1c, 1d, 1e, and 1f has almost same shape as that of the pixel area 1 shown in FIG. 1.

The scanning lines L1, L2, and L3 are arranged for the pixel areas 1a, 1b, and 1c formed as pixels of a first row, as with the method shown in FIG. 1. Droplets are ejected while the inkjet nozzles are scanned along the minor axis direction of the pixel areas 1a, 1b, and 1c. The scanning lines L4, L5, and L6 are arranged for pixel areas 1d, 1e, and 1f formed as pixels of a second row, as with the method shown in FIG. 1. Droplets are ejected while the inkjet nozzles are scanned along the minor axis direction of the pixel areas 1d, 1e, and 1f.

These operations allow a plurality of droplets to be ejected in the whole of each of the pixel areas 1a, 1b, 1c, 1d, 1e, and If dispersedly, such that the liquid material is applied to the whole of each pixel area. Then, the applied liquid material is dried. Thus the hole injection layer and light emitting layer, for example, are formed in each of the pixel areas 1a, 1b, 1c, 1d, 1e, and 1f formed on the substrate 10.

A plurality of inkjet nozzles may be formed in a nozzle head of a droplet ejecting apparatus used for the applying of a liquid material. The plurality of inkjet nozzles may be disposed at a certain interval on a straight line for example. According to this, for example, a first inkjet nozzle ejects droplets for the scanning line L1, a second inkjet nozzle adjacent to the first inkjet nozzle ejects droplets for the scanning line L2, and a third inkjet nozzle adjacent to the second inkjet nozzle ejects droplets for the scanning line L3.

Specifically, a plurality of droplets can be ejected almost simultaneously or sequentially with a plurality of inkjet nozzles for one pixel area 1.

Thus, according to the method of manufacturing a thin film pattern of the exemplary embodiment, since inkjet nozzles are scanned along the minor axis direction of the pixel areas, droplet ejection for one pixel area with a plurality of inkjet nozzles at almost the same time is implemented more easily compared to the case where inkjet nozzles are scanned along the major axis direction of the pixel area. The exemplary embodiment therefore enables a liquid material to be applied to a pixel area by a droplet ejecting method at higher speed than a related art method.

Furthermore, according to the exemplary embodiment, applying a liquid with a plurality of different inkjet nozzles for one pixel area is easier, compared to a case where inkjet nozzles are scanned along the major axis direction of the pixel area. This allows the difference (error) in the droplet ejection amounts among inkjet nozzles to be offset. Accordingly, the generation of “streak unevenness” in thin films (hole injection layer or light emitting layer) being structural elements of a pixel can be reduce or prevented such that the generation of light emitting unevenness can be reduced.

In the exemplary embodiment, droplet ejecting of multiple times for one pixel area 1 along the scanning lines L1, L2, and L3 may be implemented so that part of a thin film (dot thin film) formed by landing of one droplet overlaps with part of a dot thin film formed by landing of another droplet. This enables a thin film pattern having more uniform thickness to be formed for the whole of the pixel area 1 without a non-coated part.

In the exemplary embodiment, droplet ejecting of multiple times for one pixel area 1 along the scanning lines L1, L2, and L3 may be implemented with droplet ejection amounts of two or more kinds. For example, the droplet ejection amount may be relatively small for the scanning lines L1 and L3, and it may be relatively large for the scanning line L2. Thus, the droplet ejection amount can be large for the center area of the pixel area 1, and it can be small for the edge part of the pixel area 1. Accordingly, a desired thin film pattern can be formed at high speed without a non-coated part for the whole of the pixel area 1 while reducing or preventing the generation of “streak unevenness”.

In the exemplary embodiment, droplet ejecting of multiple times for one pixel area 1 along the scanning lines L1, L2, and L3 may be implemented with droplets having different viscosities of two or more kinds. For example, in a droplet ejecting apparatus, a liquid material of relatively high viscosity is provided to the first and third inkjet nozzles, which eject droplets along the scanning lines L1 and L3. A liquid material of relatively low viscosity is provided to the second inkjet nozzle, which ejects droplets along the scanning line L2.

Thus, droplets of high viscosity are ejected for edge parts of the pixel area 1, and droplets of low viscosity are ejected for the center area of the pixel area 1. According to the present method of manufacturing a thin film pattern, a desired thin film pattern can be formed at high speed while uniformizing the film thickness for the whole of the pixel area 1.

In the exemplary embodiment, droplet ejection of multiple times is implemented for one pixel area 1. In this process, droplet ejecting for the whole of the pixel area 1 may be completed before a first droplet that has landed on the pixel area 1 is completely dried. Specifically, droplets for the whole of one pixel area 1 may be ejected so as to form a thin film before each of multiple droplets that have landed on one pixel area 1 are completely dried. This allows the plurality of droplets that has landed on the pixel area 1 to be mixed with each other such that a flatter thin film pattern can be formed.

In the exemplary embodiment, an intermediate drying process may be involved in a process of droplet ejecting of multiple times for one pixel area 1. Specifically, droplet ejecting is implemented for one pixel area 1 by half of a given times, and then such a drying process (intermediate drying process) that the droplets that have landed are not completely dried is implemented. Then, the remaining droplet ejecting is implemented for the pixel area 1.

According to this, the volume of the droplets that have landed is decreased by the intermediate drying process, and thereafter the remaining droplet ejecting can be implemented. Thus, a thin film pattern, having large as well as even thickness, can be formed while reducing or preventing droplets from spilling out of the pixel area 1 and so on.

Furthermore, a color filter for an organic EL element may be formed using the method of manufacturing a thin film pattern of the exemplary embodiment. For example, in an organic EL element where white light is emitted from a light emitting layer and the white light is output to outside through a color filter, a thin film pattern constituting the color filter can be formed uniformly at high speed without causing “streak unevenness”. Thus, according to the present exemplary embodiment, color unevenness and so on can be reduced considerably in a display panel including an organic EL element incorporating a color filter.

Second Exemplary Embodiment

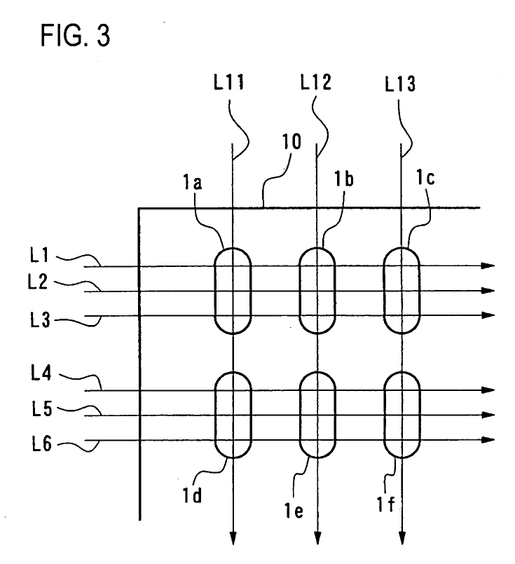

A second exemplary embodiment of the present invention will be described referring to FIG. 3. FIG. 3 is a schematic showing a method of manufacturing a thin film pattern according to a second exemplary embodiment of the invention. The second exemplary embodiment is different from the first exemplary embodiment in that not only the scanning lines L1, L2, L3, L4, L5, and L6 are arranged along the minor axis direction of the pixel areas 1a, 1b, 1c, 1d, 1e, and 1f but also scanning lines L11, L12, and L13 are arranged along the major axis direction of the pixel areas 1a, 1b, 1c, 1d, 1e, and 1f.

Specifically, the plurality of pixel areas 1a, 1b, 1c, 1d, 1e, and 1f are formed on a top surface of the substrate 10. Convex partition walls (banks) may be provided on the circumference of each of the pixel areas 1a, 1b, 1c, 1d, 1e, and 1f.

The scanning lines L1, L2, and L3 are arranged for the pixel areas 1a, 1b, and 1c formed as pixels of a first row as with the method shown in FIG. 2. Droplets are ejected while the inkjet nozzles are scanned along the minor axis direction of the pixel areas 1a, 1b, and 1c. The scanning lines L4, L5, and L6 are arranged for pixel areas 1d, 1e, and 1f formed as pixels of a second row as with the method shown in FIG. 2. Droplets are ejected while the inkjet nozzles are scanned along the minor axis direction of the pixel areas 1d, 1e, and 1f.

For the pixel areas 1a and 1d formed as pixels of a first column, the scanning line L11 is arranged in parallel with the major axis of the pixel areas. The scanning line L11 may be a plurality of scanning lines parallel with each other. For the pixel areas 1b and 1e formed as pixels of a second column, the scanning line L12 is arranged in parallel with the major axis of the pixel areas. The scanning line L12 may be a plurality of scanning lines parallel with each other. For the pixel areas 1c and 1f, formed as pixels of a third column, the scanning line L13 is arranged in parallel with the major axis of the pixel areas. The scanning line L13 may be a plurality of scanning lines parallel with each other.

Droplets are ejected in each of the pixel areas 1a, 1b, 1c, 1d, 1e, and 1f while inkjet nozzles are scanned along the scanning lines L11, L12, and L13. This droplet ejecting can be implemented in the same way as that of the droplet ejecting along the scanning lines L1, L2, and L3.

Thus, the exemplary embodiment involves an ejecting treatment for the minor axis direction where inkjet nozzles are scanned along the minor axis direction of the pixel areas 1a, 1b, 1c, 1d, 1e, and 1f, and an ejecting treatment for the major axis direction where inkjet nozzles are scanned along the major axis direction of the pixel areas 1a, 1b, 1c, 1d, 1e, and 1f. Accordingly, droplets are ejected for each of the pixel areas 1a, 1b, 1c, 1d, 1e, and 1f along the scanning lines of two kinds whose scanning directions are different from each other by 90 degrees such that the difference (error) in the ejection amount, viscosity and so on among droplets is offset. This exemplary embodiment therefore enables a state of droplet ejecting for each of the pixel areas 1a, 1b, 1c, 1d, 1e, and I f to be reduced or prevented from biasing toward a linear state. Thus, the generation of “streak unevenness” in a thin film pattern constituting a pixel can be avoided more effectively.

Third Exemplary Embodiment

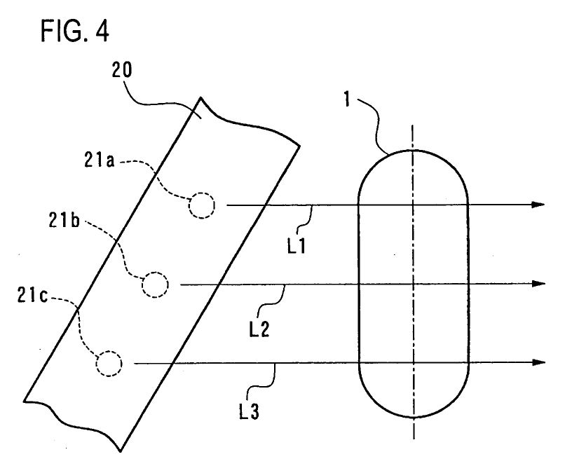

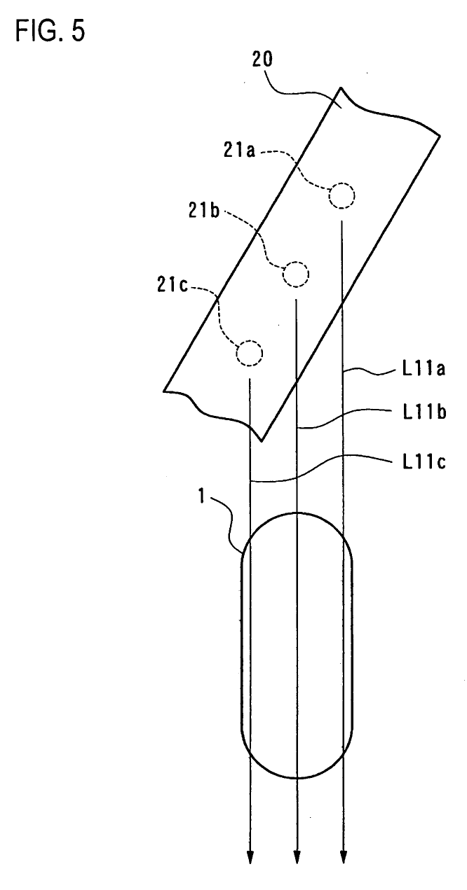

A third exemplary embodiment of the present invention will be described referring to FIGS. 4 and 5. FIG. 4 is a schematic showing a method of manufacturing a thin film pattern according to a third exemplary embodiment of the invention. In the exemplary embodiment, a droplet ejecting apparatus where a plurality of inkjet nozzles 21a, 21b, and 21c are formed in a nozzle head 20 is used. Each of the inkjet nozzles 21a, 21b, and 21cmay be disposed at a certain interval on a certain straight line in the nozzle head 20.

For the pixel area 1, the plurality of scanning lines L1, L2, and L3 are arranged in parallel with the minor axis of the pixel area 1. Then, the nozzle head 20 is moved along the minor axis direction of the pixel area 1 so that the inkjet nozzle 21a moves above the scanning line L1, the inkjet nozzle 21b above the scanning line L2, and the inkjet nozzle 21c above the scanning line L3.

Here, the nozzle head 20 is moved so that the straight line defining the disposition locations of the inkjet nozzles 21a, 21b, and 21c, diagonally intersects with the scanning lines L1, L2, and L3, specifically, the front face of the nozzle head 20 is opposed to the scanning lines L1, L2, and L3 diagonally. In the movement process of the nozzle head 20, droplets are ejected from the inkjet nozzles 21a, 21b, and 21c so as to form a thin film pattern in the pixel area 1.

According to the exemplary embodiment, interval of movement paths (scanning lines L1, L2, and L3) of the plurality of inkjet nozzles 21a, 21b, and 21c formed in the nozzle head 20 can be set shorter than interval of the inkjet nozzles 21a, 21b, and 21c. Thus, droplets can be ejected almost simultaneously or sequentially with more inkjet nozzles for one pixel area 1 such that a thin film pattern constituting a pixel can be formed at higher speed while reducing “streak unevenness” for a large pixel as well as a small pixel.

A modification of the exemplary embodiment will be described referring to FIG. 5. FIG. 5 is a schematic showing a method of manufacturing a thin film pattern according to the modification of the exemplary embodiment. In the present method of manufacturing a thin film pattern, when scanning the nozzle head 20 along the major axis direction of the pixel area 1, the nozzle head 20 is moved so that the front face of the nozzle head 20 diagonally faces the major axis direction (specifically, scanning lines L11a, L11b, and L11c). In the movement process of the nozzle head 20, droplets are ejected from the inkjet nozzles 21a, 21b, and 21c so as to form a thin film pattern in the pixel area 1.

According to the modification, interval of movement paths (the scanning lines L11a, L11b, and L11c) of the plurality of inkjet nozzles 21a, 21b, and 21c formed in the nozzle head 20 can be set shorter than the interval of the inkjet nozzles 21a, 21b, and 21c. Thus, even when the nozzle head 20 is scanned along the major axis direction of the pixel area 1, droplets can be ejected almost simultaneously or sequentially with more inkjet nozzles for one pixel area 1. Accordingly, a thin film pattern constituting a pixel can be formed at higher speed while reducing “streak unevenness” for a large pixel as well as a small pixel.

Method of Manufacturing Organic EL Device

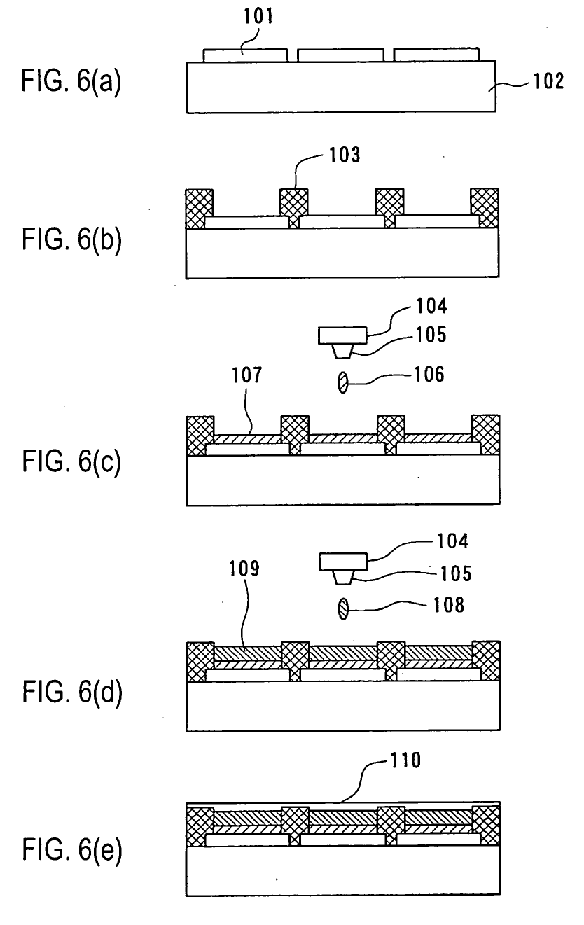

A method of manufacturing an organic EL device using the method of manufacturing a thin film pattern according to exemplary embodiments 1 through 3 will be described specifically with reference to FIG. 6. In the present manufacturing method, a hole injection and transport layer in an organic EL device is formed by the method of manufacturing a thin film pattern of the above exemplary embodiments.

A composition for hole injection and transport layer includes a conductive compound that forms a hole injection and transport layer, a dispersion solvent, and a wetting agent, and is used in pattern deposition by a droplet ejecting method. A compound whose ionization potential is lower than that of an anode is desirable as a conductive compound forming the hole injection and transport layer. For example, when indium tin oxide (ITO) is used as an anode, a porphyrin compound, such as copper phthalocyanine is listed as a small molecule material.

Other additive agent and film stabilizing material may be added. For example, a viscosity adjusting agent, an antiaging agent, a pH adjusting agent, an antiseptic agent, a resin emulsion, a leveling agent, and so on may be used.

The physical properties of compounds for hole injection and transport layer in the case of using copper phthalocyanine as a conductive compound (component of hole injection and transport layer) were studied. As samples, compositions A through J shown in Tables 1 through 10 were prepared.

TABLE 1
Composition A

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 70 |
| Wetting agent | Glycerin | 5 |

TABLE 2
Composition B

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 65 |
| | Methanol | 5 |
| Wetting agent | Glycerin | 5 |

TABLE 3
Composition C

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 65 |
| | Ethoxyethanol | 5 |
| Wetting agent | Glycerin | 5 |

TABLE 4
Composition D

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Methanol | 70 |
| Wetting agent | Glycerin | 5 |

TABLE 5
Composition E

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | N,N-methylformamide | 70 |
| Wetting agent | Glycerin | 5 |

TABLE 6
Composition F

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 75 |
| Wetting agent | — | 0 |

TABLE 7
Composition G

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 70 |
| | Methanol | 5 |
| Wetting agent | — | 0 |

TABLE 8
Composition H

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 70 |
| | Ethoxyethanol | 5 |
| Wetting agent | — | 0 |

TABLE 9
Composition I

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 65 |
| | Butoxyethanol | 5 |
| Wetting agent | Glycerin | 5 |

TABLE 10
Composition J

| | Composition | Content (wt %) |
|---|---|---|
| Component of hole | Copper phthalocyanine | 25 |
| injection and transport | (10 wt %) (Styrene acrylic | |
| layer | resin dispersion liquid) | |
| Polar solvent | Water | 65 |
| | Isopropyl alcohol | 5 |
| Wetting agent | Glycerin | 5 |

### Evaluation on Ejection

With regard to the compositions A through H shown in Tables 1 through 8, the contact angle With respect to a nozzle surface forming material constituting an inkjet head, viscosity, and surface tension were measured, and ejection property were evaluated. The evaluation on ejection was implemented using an inkjet print apparatus (Seiko Epson Co., Ltd, MJ-500C).

Viscosity is shown as a measured value at 20 degrees centigrade. The results are shown in Table 11.

TABLE 11

| | Contact angle | Viscosity | Surface tension | Ejection |
|---|---|---|---|---|
| Composition | [degree] | [cp] | [dyne] | property |
| A | 135 | 3.8 | 62.8 | ◯ |
| B | 91 | 3.6 | 40.8 | ◯ |
| C | 62 | 3.1 | 39.8 | ⊚ |
| D | 22 | 0.8 | 23.1 | X |
| E | 175 | 0.9 | 81.0 | X |
| F | 118 | 1.1 | 71.0 | X |
| G | 28 | 0.8 | 68.8 | X |
| H | 27 | 0.9 | 69.2 | X |

From the results, it is apparent that contact angle may be in the range of 30 to 170 degrees, especially in the range of 35 to 65 degrees. In addition, viscosity is preferably in the range of 1 to 20 cp, especially in the range of 2 to 4 cp. Surface tension is preferably in the range of 20 to 70 dyne, especially in the range of 25 to 40 dyne.

Furthermore, it is apparent that the compositions A through C, into which glycerin is mixed as a wetting agent, are superior in ejection property compared to the compositions F through H, where a wetting agent is not mixed. A wetting agent therefore may be included in an ink composition. An ink composition can be prevented from drying and solidifying at a nozzle orifice effectively by mixing a wetting agent. As such a wetting argent, for example, polyhydric alcohols, such as glycerin and diethylene glycol are named. Glycerin is especially preferable.

Method of Preparing Composition for Hole Injection and Transport Layer;

The compositions A through C, I, and J shown in Tables 1 through 3, 9, and 10, respectively, were prepared, and then the particle size distribution of compound for forming hole injection and transport layer (copper phthalocyanine) of these compositions were measured before and after ultrasonic treatment. Furthermore, evaluated was the film forming property of a hole injection and transport layer that was formed using the above composition for hole injection and transport layer that has passed through a filtering process after ultrasonic treatment, by patterning using a droplet ejecting method.

The results are shown in Table 12. The effect of ultrasonic treatment is indicated with percentage of particles whose particle size is 1 micrometer or less in particle size distribution. The particle diameter thereof is 1 micrometer or more in styrene acrylic resin dispersion liquid.

TABLE 12

| | Ratio of particles with particle diameter | | |
|---|---|---|---|
| | of 1 micrometer or less (%) | | |
| | Before ultrasonic | After ultrasonic | Film forming |
| Composition | treatment | treatment | property |
| A | 4.8 | 46.8 | ◯ |
| B | 2.8 | 31.4 | ◯ |
| C | 4.2 | 43.5 | ⊚ |
| I | 2.5 | 18.5 | X |
| J | 3.9 | 18.2 | X |

From this result, it is apparent that dispersibility can be enhanced by treating the dispersion liquid with ultrasonic treatment for four hours. A more uniform film of hole injection and transport layer can be achieved by further filtering the ultrasonic treated dispersion liquid. As a dispersion polar solvent for a conductive compound, water or mixed solvent of water and methanol, or water and ethoxyethanol (the compositions A through C) is preferable. When these solvents are used, film forming property is excellent.

Manufacturing Process for Organic Electro-luminescent Element

An organic electro-luminescent element (light emitting layer) was fabricated by implementing pattern deposition of a hole injection and transport layer using the compositions A through C shown in Tables 1 through 3 by a droplet ejecting method through the following procedures.

Anode Forming (FIG. 6(a))

An anode 101 is formed on a glass substrate 102. The glass substrate 102 may have a reduced tendency to erosion by chemicals such as acid and alkali and can be mass-produced. An ITO transparent electrode is deposited on the substrate 102 with thickness of 0.1 micrometers and then the electrode is patterned in a 100 micrometers pitch for example.

Partition Member Forming (FIG. 6(b))

A partition member 103 is formed on the glass substrate 102. Specifically, with filling between the electrodes (ITO electrodes) 101, a nonphotosensitive polyimide (partition member) also serving as a wall (bank) to prevent ink dripping is formed by photolithography. The method of manufacturing a thin film pattern of the exemplary embodiments shown in FIGS. 1 through 5 may be used to form the partition member 103. The width and thickness of the partition member 103 are 20 micrometers and 2.0 micrometers, respectively.

Ejecting Composition for Hole Injection and Transport Layer (FIG. 6 (c))

The compositions A through C for hole injection and transport layer (numeral 106 in the drawing) are ejected from a head 105 of an inkjet print apparatus (Seiko Epson Co., Ltd MJ-800C) 104 and thus a hole injection and transport layer 107 is pattern deposited. In this film forming, the method of manufacturing a thin film pattern of the exemplary embodiments shown in FIGS. 1 through 5 was used. After the pattern deposition, a hole injection and transport layer was formed by drying treatment at 200 degrees centigrade for 10 minutes. In the ejection of a composition for hole injection and transport layer, a pattern of hole injection and transport layer of high precision and less “streak unevenness” was obtained without coating over a bank.

Filling Composition for Light Emitting Layer FIG. 6(d))

Then, a PPV (poly (para-phenylene vinylene)) precursor composition was prepared as a green light emitting layer. A composition 108 for a light emitting layer was ejected by a droplet ejecting method so as to pattern-deposit a light emitting layer 109. In this film forming also, the method of manufacturing a thin film pattern of the exemplary embodiments shown in FIGS. 1 through 5 was used. As the light emitting layer 109, PPV into which rhodamine B showing red-light emitting is doped, and PPV into which coumarin showing blue-light emitting is doped may be used. Thus, light emitting layers showing three primary colors of red, green, and blue are further patterned on the hole injection and transportlayer. Thereby a full color organic EL display of high quality without color unevenness can be manufactured.

Cathode Forming (FIG. 6(e))

Finally, a cathode 110 is vapor deposited in a manner of covering the light emitting layer 109 so as to complete an organic electro-luminescent element.

According to the method of manufacturing an organic EL device, an organic EL device without color unevenness of a streak shape and so on can easily be realized in short time and at low cost.

Method of Manufacturing Plasma Display Panel

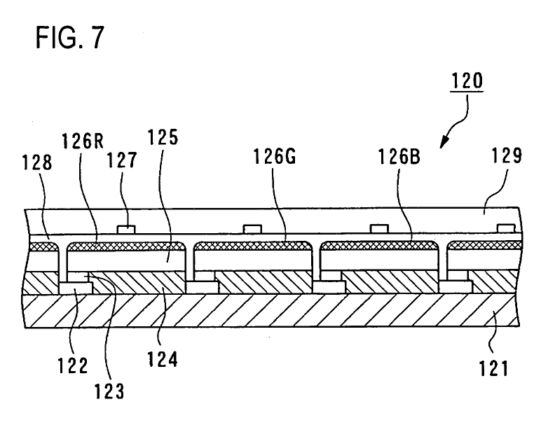

A method of manufacturing a plasma display panel using the method of forming a thin film pattern of the exemplary embodiments will be described in detail with reference to FIG. 7. In the present manufacturing method, an electrode wiring pattern in a plasma display panel is formed by the method of manufacturing a thin film pattern of the above exemplary embodiments. FIG. 7 is a sectional schematic showing one example of a plasma display panel manufactured by using the method of manufacturing a thin film pattern according to the exemplary embodiments.

A plasma display panel 120 is formed by joining two glass substrates 121 and 129, and filling the space between the both substrates with inert gas. Electrodes (a transparent electrode 122, a bus electrode 123, and an address electrode 127) and so on that are formed by the method of manufacturing a thin film pattern according to the exemplary embodiment are provided on the glass substrates 121 and 129. The structure of the plasma display panel 120 will be described in detail.

In the plasma display panel 120, sustain electrodes are arranged for each line of a cell row in horizontal direction of a screen on an inner surface of the glass substrate 121, which is on a viewing side, of the pair of substrates sandwiching discharge space 125 therebetween. The sustain electrode includes the transparent electrode 122 that is a transparent conductive film, and the bus electrode 123 that is a metal film for reducing resistance value. The transparent electrode 122 and the bus electrode 123 are provided by the method of manufacturing a thin film pattern shown in FIGS. 1 through 5. Specifically, the transparent electrode 122 is an indium tin oxide formed by the droplet ejecting method shown in FIGS. 1 through 5. The bus electrode 123 is also formed using the droplet ejecting method shown in FIG. 1.

The transparent electrode 122 and the bus electrode 123 are covered with a dielectric layer 124 for alternate current driving. The dielectric layer 124 has optical transparency. The address electrode 127, a partition wall 128, and three colors (red R, green G, and blue B) phosphors 126R, 126G, and 126B for color display are provided inside the glass substrate 129, which is on a back surface side. The discharge space 125 is subdivided for each unit light emitting area along a line direction by the partition wall 128. The discharge space 125 is filled with a discharge gas, such as argon or neon. The phosphors 126R, 126G, and 126B are locally excited with ultraviolet rays caused by discharge so as to emit visible light of a given color. A light emitting area of one unit in display is formed of three unit light emitting areas arranged along a line direction. A structure within the range of each unit light emitting area is a cell.

A manufacturing process of the plasma display panel 120 having the above structure will be described. Of two glass substrates 121 and 129, the glass substrate 121 on a viewing side (display surface side) is referred to as a substrate structure of viewing surface side. The glass substrate 129, which is an opposite side (back surface side) of the glass substrate 121, is referred to as a substrate structure of back surface side, hereinafter.

With regard to the substrate structure of viewing surface side, the transparent electrode 122 is formed on the glass substrate 121 having optical transparency. The transparent electrode 122 is formed by applying an indium tin oxide by the method shown in FIGS. 1 through 5. Then, the bus electrode 123 is formed on the transparent electrode 122. The bus electrode 123 is also formed by applying a conductive material by the method shown in FIGS. 1 through 5. The dielectric layer 124 covering the transparent electrode 122 and the bus electrode is formed, and thereby the substrate structure of viewing surface side is completed.

Meanwhile, with regard to the substrate structure of back surface side, the address electrode 127 is formed on the glass substrate 129 first. The address electrode 127 is also formed by applying a conductive material by the method shown in FIGS. 1 through 5. Then, the partition wall 128 is formed, and thereafter the phosphors 126R, 126G, and 126B are provided in the space separated by the partition wall 128 using a screen-printing method and so on. The phosphors 126R, 126G, and 126B are formed by applying a phosphor paste by a screen-printing method. The phosphor paste is prepared, for example, by blending a phosphor powder of a certain emission color, and a vehicle composed of cellulose or acrylic thickening resin and an organic solvent of alcohols, esters, or the like. The phosphor 126R emitting red light, the phosphor 126G emitting green light, the phosphor 126B emitting blue light are formed along a direction of the address electrode 127 by turns. Next, heat treatment is implemented for the phosphors 126R, 126G, and 126B in an air atmosphere at air pressure so as to evaporate a volatile component of the vehicle. This heat treatment is referred to as annealing process for phosphors.

After annealing of the phosphors 126R, 126G, and 126B is completed, the substrate structure of viewing surface side and the substrate structure of back surface side are joined. Then, the inside thereof is evacuated to vacuum. Thereafter the inside is filled with inert gas so as to complete the plasma display panel 120.

Thus, in the method of manufacturing the plasma display panel 120 of the exemplary embodiment, the method of manufacturing a thin film pattern (droplet ejecting method) according to the exemplary embodiments is used to form the transparent electrode 122, the bus electrode 123, and the address electrode 127 such that the amount of wasted indium tin oxide and conductive material can greatly be reduced compared to the case of manufacturing by photolithography and etching. Furthermore, in the method of manufacturing the plasma display panel 120 of the exemplary embodiment, a manufacturing period can be shortened while manufacturing cost can be reduced since there is no need to fabricate a photo mask when forming the transparent electrode 122, the bus electrode 123, and the address electrode 127.

In the plasma display panel 120 of the exemplary embodiment, even if the bus electrode 123 involves breaking, the electrode is connected as a wiring on the substrate since the transparent electrode 122 composed of indium tin oxide is formed under the conductive pattern. The electrode therefore can play a given function in the plasma display panel 120.

In addition, in the plasma display panel 120 of the exemplary embodiment, when forming the transparent electrode 122, the bus electrode 123, and the address electrode 127 by a droplet ejecting method, droplets are ejected with arranging scanning lines along the minor axis direction of a formation area of a thin film pattern as shown in FIGS. 1 through 5. Accordingly, the thin film pattern can be formed at high speed while reducing the generation of “streak unevenness” in the thin film patterns constituting the transparent electrode 122, the bus electrode 123, and the address electrode 127. Thus, according to the present manufacturing method, the transparent electrode 122, the bus electrode 123, and the address electrode 127 of the plasma display panel 120 can be formed precisely and rapidly such that a plasma display panel 120 that can display high quality image, and where defects such as current leakage, hardly occurs, is provided at low cost.

Method of Manufacturing Liquid Crystal Device

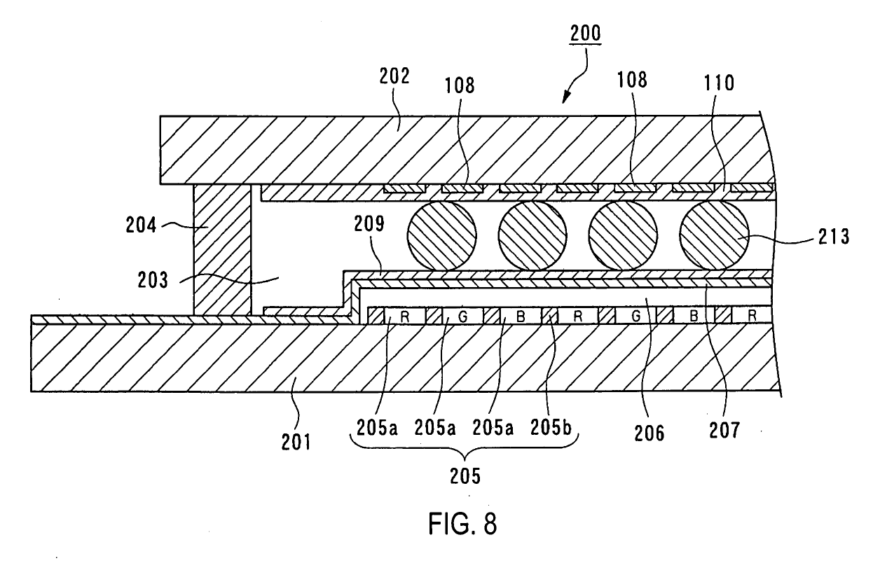

A method of manufacturing a liquid crystal device using the method of forming a thin film pattern of the exemplary embodiments will be described in detail with reference to FIG. 8. In the present manufacturing method, an electrode wiring pattern and a color filter in a liquid crystal device is formed by the coating method of the above exemplary embodiments. FIG. 8 is a sectional schematic showing one example of a liquid crystal device 200 manufactured by using the method of manufacturing a thin film pattern according to the exemplary embodiment.

As shown in FIG. 8, over a surface of a lower side substrate 201 that is on a liquid crystal layer 203 side, a color filter 205, a planarization film 206 formed of an organic film and so on, a transparent electrode 207, and an alignment film 209 are sequentially deposited in this order from bottom. Meanwhile, over a surface of an upper side substrate 202 that is on a liquid crystal layer 203 side, a transparent electrode 208 composed of indium tin oxide and an alignment film 210 are sequentially deposited. Many spherical spacers 213 are disposed in the liquid crystal layer 203.

The color filter 205 includes colored layers 205a of red (R), green (G), and blue (B) formed in a given pattern, and a light shielding layer (black matrix) 205b that shields light between the adjacent colored layers 205a. Alignment films 209 and 210 are composed of oriented polymer, such as polyimide, and the surfaces thereof are rubbed in a given direction with a cloth and the like according to the orientation state of the liquid crystal layer 203 when an electric field is not applied thereto. The color filter 205 and the planarization film 206 are formed at least within a display area, and only the inner side of a sealing material 204.

A method of manufacturing the liquid crystal device 200 of the above structure will be described.

First, the color filter 205, the planarization film 206, the transparent electrode 207, and the alignment film 209 are sequentially formed over the surface of the lower side substrate 201. The color filter 205 and the transparent electrode 207 are formed by the method of manufacturing a thin film pattern shown in FIGS. 1 through 5.

The transparent electrode 208 and the alignment film 210 are sequentially formed over a surface of the upper side substrate 202. The transparent electrode 208 is also formed by the method of manufacturing a thin film pattern shown in FIGS. 1 through 5. Specifically, droplets of indium tin oxide are ejected onto a surface of the substrate 202 with a droplet ejecting apparatus. Thus the transparent electrode 208 is formed.

Then, the lower side substrate 201 where the color filter 205, the planarization film 206, the transparent electrode 207, and the alignment film 209 are sequentially deposited, and the upper side substrate 202 where the transparent electrode 208 and the alignment film 210 are sequentially formed are joined to each other with the sealing material 204 that is uncured. Thereafter, the sealing material 204 is cured in a manner of forming an inlet opening for liquid crystal so as to form a liquid crystal cell.

Next, liquid crystal is sucked into the liquid crystal cell by vacuum injection method so as to form the liquid crystal layer 203. Thereby the liquid crystal device 200 of the above structure is manufactured.

Thus, in the method of manufacturing the liquid crystal device 200 of the exemplary embodiment, the transparent electrodes 207 and 208 composed of indium tin oxide and the like are formed by a droplet ejecting method such that the amount of wasted indium tin oxide and so on can greatly be reduced compared to the case of manufacturing by photolithography and etching.

Furthermore, in the method of manufacturing the liquid crystal device 200 of the exemplary embodiment, manufacturing period can be shortened while manufacturing cost can be reduced since there is no need to fabricate a photo mask when forming the transparent electrodes 207 and 208.

Furthermore, in the method of manufacturing the liquid crystal device 200 of the exemplary embodiment, when forming the color filter 205, and the transparent electrodes 207 and 208 by a droplet ejecting method, droplets are ejected by the method shown in FIGS. 1 through 5. Accordingly, the liquid crystal device 200 of less streak light emitting unevenness and high quality can be manufactured at high speed.

Electronic Apparatus

Examples of an electronic apparatus incorporating an electro-optical device (organic EL device, plasma display panel, or liquid crystal device) manufactured using the method of manufacturing a thin film pattern of the above exemplary embodiments will be described.

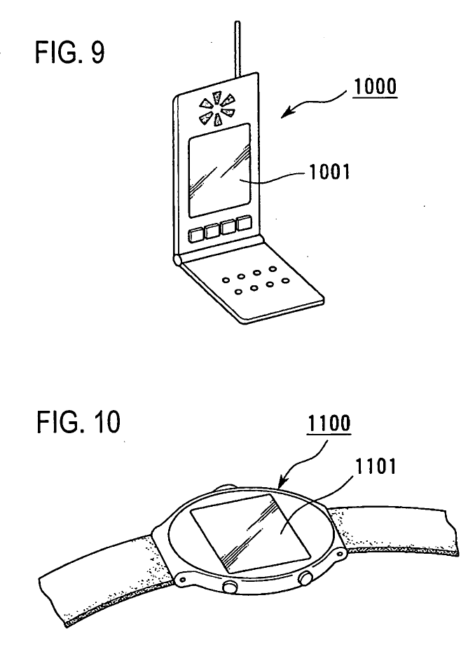

FIG. 9 is a schematic view showing one example of a cellular phone. Referring to FIG. 9, reference numeral 1000 denotes a main body of a cellular phone, and reference numeral 1001 denotes a display part where the above electro-optical device is used.

FIG. 10 is a schematic view showing one example of a wristwatch electronic apparatus. Referring to FIG. 10, reference numeral 1100 denotes a main body of a wristwatch, and reference numeral 1101 denotes a display part where the above electro-optical device is used.

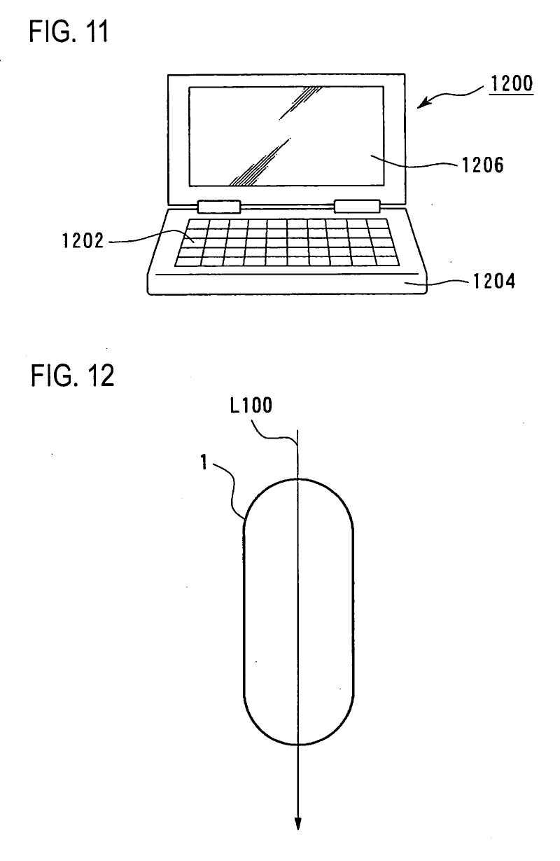

FIG. 11 is a schematic view showing one example of mobile information processing devices, such as a word processor and a personal computer. Referring to FIG. 11, reference numeral 1200 denotes an information processing device, 1202 an input part, such as a keyboard, 1204 a main body of an information processing device, and 1206 a display part using the above electro-optical device.

The electronic apparatus shown in FIGS. 9 through 11 include the electro-optical device of the above exemplary embodiments such that a high quality electronic apparatus where light emitting unevenness, current leakage and so on in a display part and so on are reduced can be provided at low cost.

The technical scope of the present invention is not limited to the above exemplary embodiments, and various modifications can be applied to the invention without departing from the spirit of the invention. The concrete materials and layer structures described in the exemplary embodiments are only examples, and modification can appropriately be applied thereto.

1. A method of manufacturing a thin film pattern, comprising:
a liquid applying treatment where a liquid material is applied to a pixel area having a major axis and a minor axis by a droplet ejecting method; and
an ejecting treatment along a minor axis direction where, in the liquid applying treatment, a nozzle head of a droplet ejecting apparatus is scanned along the minor axis direction of the pixel area, and droplets are ejected to the pixel area from an inkjet nozzle included in the nozzle head in the scanning process.

2. The method of manufacturing a thin film pattern according to claim 1,
droplet ejecting of multiple times being implemented for a single pixel area in the ejecting treatment along the minor axis direction;
the inkjet nozzle including a plurality of inkjet nozzles; and
the droplet ejecting of multiple times being implemented with at least two of the inkjet nozzles different from each other.

3. The method of manufacturing a thin film pattern according to claim 2,
the droplet ejecting of multiple times for a single pixel area being implemented almost simultaneously or sequentially with at least two of the inkjet nozzles adjacent to each other.

4. The method of manufacturing a thin film pattern according to claim 2, wherein the droplet ejecting of multiple times for a singl pixel area being implemented with at least two droplet ejection amounts.

5. The method of manufacturing a thin film pattern according to claim 2, the droplet ejecting of multiple times for a single pixel area being implemented with at least two viscosities of the droplets.

6. The method of manufacturing a thin film pattern according to any of claim 1,
the nozzle head including a plurality of inkjet nozzles; the plurality of inkjet nozzles being disposed on a substantially straight line in the nozzle head; and
the nozzle head being scanned while the straight line defining a location of the plurality of inkjet nozzles diagonally intersects with a scanning line arranged along the minor axis direction, in the ejecting treatment along the minor axis direction.

7. A method of manufacturing a thin film pattern according to claim 2, wherein the last droplet being ejected before the droplet that has landed on the pixel area first is almost completely dried, in the droplet ejecting of multiple times for a single of the pixel area.

8. The method of manufacturing a thin film pattern according to claim 2, a drying process such that the droplets that have landed on the pixel area are not completely dried being implemented between the first droplet ejecting and the last droplet ejecting for the pixel area, in the droplet ejecting of multiple times for a single of the pixel area.

9. The method of manufacturing a thin film pattern according to claim 8, further comprising:
an ejecting treatment along a major axis direction where, in the liquid applying treatment, the nozzle head of the droplet ejecting apparatus is scanned along a major axis direction of the pixel area, and droplets are ejected to the pixel area from the inkjet nozzle included in the nozzle head in the scanning process.

10. The method of manufacturing a thin film pattern according to claim 1, the nozzle head being scanned while a straight line defining a location of the plurality of inkjet nozzles diagonally intersects with a scanning line arranged along a major axis direction, in the ejecting treatment along the major axis direction.

11. The method of manufacturing a thin film pattern according to claim 2, the droplet ejecting of multiple times for a single of the pixel area being implemented so that part of a thin film formed by a landing of one droplet overlaps with part of a thin film formed by landing of another droplet.

12. A method of manufacturing an organic electro-luminescent element where a light emitting element having a light emitting layer and a hole injection layer between electrodes is formed over a substrate, comprising:
forming the hole injection layer by ejecting droplets with an inkjet head formed in a droplet ejecting apparatus,
the hole injection layer being formed in a pixel area having a major axis and a minor axis; and
the inkjet head being scanned along a minor axis direction of the pixel area, and the droplets being ejected to the pixel area from an inkjet nozzle in the scanning process.

13. A method of manufacturing an organic electro-luminescent element where a light emitting element having a light emitting layer and a hole injection layer between electrodes is formed over a substrate, comprising:
forming the light emitting layer by ejecting droplets with an inkjet head formed in a droplet ejecting apparatus,
the light emitting layer being formed in a pixel area having a major axis and a minor axis, and
the inkjet head being scanned along a minor axis direction of the pixel area, and the droplets being ejected to the pixel area from an inkjet nozzle in the scanning process.

14. A method of manufacturing a color filter formed on a light emitting direction side of a light emitting element that is formed over a substrate and includes a light emitting layer and a hole injection and transport layer between electrodes, comprising:
forming the color filter by ejecting droplets with an inkjet head formed in a droplet ejecting apparatus,
the color filter being formed in a pixel area having a major axis and a minor axis; and
the inkjet head being scanned along a minor axis direction of the pixel area, and the droplets are ejected to the pixel area from an inkjet nozzle in the scanning process.

15. A method of manufacturing a plasma display panel having electrodes formed on a substrate, comprising:
forming the electrodes by ejecting droplets with an inkjet head formed in a droplet ejecting apparatus, the electrodes being formed in a pixel area having a major axis and a minor axis; and
the inkjet head being scanned along a minor axis direction of the pixel area, and the droplets are ejected to the pixel area from an inkjet nozzle in the scanning process.

16. A method of manufacturing a liquid crystal display panel having a color filter formed on a substrate, comprising:
forming the color filter by ejecting droplets with an inkjet head formed in a droplet ejecting apparatus,
the color filter being formed in a pixel area having a major axis and a minor axis; and
the inkjet head being scanned along a minor axis direction of the pixel area, and the droplets are ejected to the pixel area from an inkjet nozzle in the scanning process.

17. The method of manufacturing a thin film pattern according to claim 1 the liquid material forming a photo resist film.

18. An electronic apparatus, comprising:
a thin film pattern manufactured using the method of manufacturing a thin film pattern according to claim 1.
